(19) United States
(12) Patent Application Publication
(10) Pub. No.: US 2010/0186843 A1
(43) Pub. Date: Jul. 29, 2010

(54) Guiding device for a metal bellows

(76) Inventors: Marc Wellner, Gams (CH); Herbert Baltes, Losheim (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/452,941

(22) PCT Filed: Apr. 5, 2008
(86) PCT No.: PCT/EP2008/002728

§ 371 Date: Mar. 17, 2010

(30) Foreign Application Priority Data
Aug. 1, 2007 (DE) 10 2007 036 487.5

(51) Int. Cl. F16L 55/04; F01B 19/00

(52) U.S. Cl. 138/30; 92/45; 138/121

(57) ABSTRACT

A guiding device for a metal bellows (3), which on at least one bellows end (37) comprises an end body (39) movable along the wall of a housing (10) during the expansion and contraction of the bellows (3), a guiding element being provided between said end body and the housing (10), is characterized in that the guiding element is formed by a plurality of separate guiding bodies (49) that are disposed in intervals from each other on the circumference of the end body (39).

The invention relates to a guiding device for a metal bellows which, on at least one end of the bellows, has an end body which can be moved along the wall of a housing at least when the bellows expands and contracts, there being a guiding element between the end body and the housing.

Metal bellows are used in various technical domains as a component of variable length, for example, when it is necessary to equalize length in lines or coupling connections for flowable media. Metal bellows are also common in hydraulic accumulators as a movable separating element between the gas side and fluid side. Especially in applications in which relatively extensive movements take place during expansion and contraction of the bellows, it is important for the service life of the bellows that the respective end of the bellows which is moved along a housing wall in operation is reliably guided.

As can be taken from document EP 1 052 412 A2, it is prior art with respect to the present invention to provide a guiding element on the movable end of the pertinent bellows. In the known solution in which the movable end body of the bellows is a sealing body which for a hydraulic accumulator within the accumulator housing separates the gas side from the fluid side, the guiding element is a guide ring which surrounds the outside periphery of the sealing body and forms an external sliding surface which can be moved along the inside wall of the accumulator housing.

This known solution is disadvantageous in several respects. On the one hand, production is complex because the guide ring which is L-shaped in cross section is fixed on the outer periphery of the sealing body by welding. On the other hand, there are corresponding production efforts due to the guide ring having to be provided with a series of openings which allow passage of media during the axial movements of the sealing body.

With respect to this prior art, the object of the invention is to make available a guiding device which is characterized by comparison by a simpler construction which enables especially economical production.

According to the invention this object is achieved by a guiding device which has the features of claim 1 in its entirety.

The essential feature of the invention according to the characterizing part of claim 1 consists in that instead of a guide ring which extends over the entire periphery of the end body of the bellows, there are several separate guide bodies. The mutual distances of the guide bodies from one another obviates the necessity of providing openings for passage of media. In contrast to a guide ring which extends over the entire length of the periphery, the invention also saves weight so that response behavior is improved since the expansion and contraction movements of the bellows are counteracted by a lower mass inertia. Moreover, operating behavior is also improved by guidance taking place with reduced friction.

The invention is especially suited for applications in which the end body is a sealing body which tightly seals the interior of the bellows on one end, i.e., for applications in which the expansion and contraction of the bellows lead to changes in the volume of the pertinent medium spaces.

In these applications the sealing body can be made cup-shaped and can have a circular ring-shaped peripheral edge which overlaps the pertinent end of the bellows and which is connected to a circular cylindrical side wall of the cup which extends into the interior of the bellows, and the guide bodies can be formed by guide shoes which in cross section have a U-like profile, and overlapping the peripheral edge of the cup, with one profile leg at a time forming a sliding surface on the housing wall. These embodiments are characterized by especially simple production and assembly because the guide shoes, by their overlapping the peripheral edge of the cup which forms the sealing body, due to their elasticity, can be clamped to the peripheral edge in the manner of a clip, and there can be catch elements for the formation of interlocking.

Preferably, the guide shoes are formed by a plastic material with good sliding properties, a lightweight construction resulting which can be easily produced by injection molding.

In especially advantageous embodiments, the sealing body of the bellows is designed as a movable separating element between the gas side and fluid side of a hydraulic accumulator, the guide bodies being used as sliding bodies which can be moved lengthwise along the inside wall of the accumulator housing. Due to the configuration of the guiding device according to the invention this hydraulic accumulator is characterized by especially favorable operating behavior.

In especially preferred embodiments, one end of the bellows is fixed on the bottom plate of the accumulator housing which has an opening for fluid entry into the interior of the bellows whose sealing body located on the other end defines within the accumulator housing the respective volumes of the gas side and fluid side which is located within the bellows according to the motion during the expansion and contraction of the bellows. The bottom of the cup which forms the sealing body can especially advantageously have an annular rib which projects on the inside of the bellows into the interior of the fluid space and which, when the bellows are completely contracted, as an end position limit interacts with a contact and centering arrangement on the bottom plate of the accumulator housing. In this way, the cup which is used as the sealing body is guided not only during the motion along the accumulator housing, but travels into a defined end position which is centered in the housing upon contraction.

Advantageously, the contact and centering arrangement can have an annular groove which is recessed in the bottom plate, and in which for interaction with the annular rib of the cup an elastomer gasket which the rib adjoins in the end position of the bellows, and a metallic centering ring are held, which has an oblique centering surface against which the annular rib of the cup runs when travelling into the end position. As is detailed below in the description using the drawings, the elastomer gasket in interaction with the annular rib of the cup also forms a type of end position damping, while the slant of the centering ring causes orientation into the end position.

According to claim 11, the subject matter of the invention is also a hydraulic accumulator with an accumulator housing in which the movable separating element between the gas side and the fluid side is a metal bellows, for the latter there being a guiding device according to one of claims 1 to 10.

The invention is detailed below using one embodiment shown in the drawings.

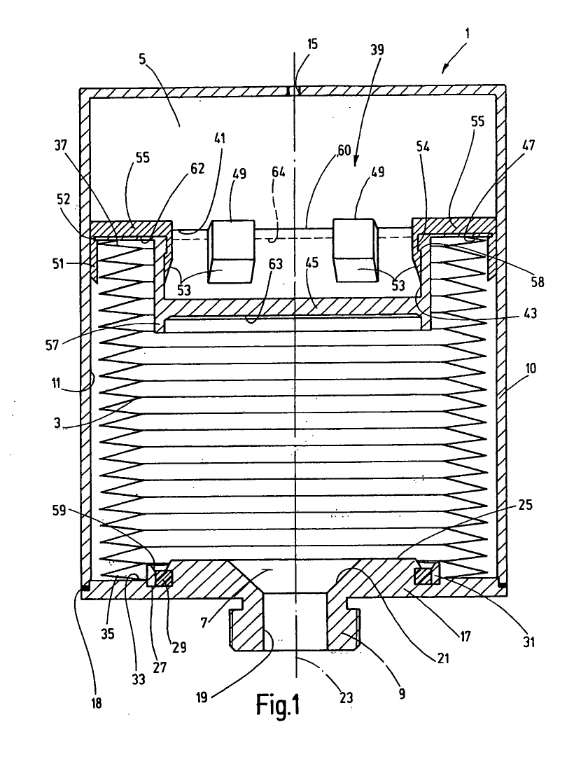

FIG. 1 shows a longitudinal section of a hydraulic accumulator which is depicted schematically highly simplified, with a metal bellows which is used as the movable separating element between the gas side and fluid side, provided with a guiding device according to one embodiment of the invention and

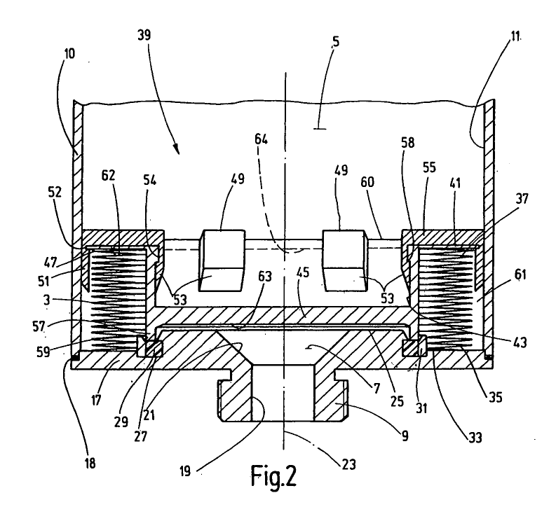

FIG. 2 shows a partial longitudinal section, which is depicted schematically highly simplified, of only the bottom area of the accumulator from FIG. 1 which has the fluid port, the metal bellows being completely contracted.

The invention is explained below using an application example in which a hydraulic accumulator 1 in the interior of its accumulator housing has a metal bellows 3 as a movable separating element between the gas side 5 which holds a working gas, and a fluid side 7. The latter is connected to the fluid port 9 for supply of the pertinent working fluid (usually hydraulic oil). The accumulator housing itself over at least the section of length in which motion of the bellows 3 takes place during expansion and contraction, forms a hollow circular cylinder 10 with whose inner wall 11 the guiding device of the metal bellows 3 interacts in order to guide the latter during expansion and contraction. On the end of the accumulator housing assigned to the gas side 5 is the fill port 15 for a working gas, such as N₂.

On the end of the accumulator housing which has a fluid port 9, there is a circular bottom plate 17 whose peripheral edge at 18 is welded to the end edge of the hollow cylinder 10. The bottom plate 17 has a central through opening 19 via which access from the fluid port 9 to the fluid side 7 is formed in the interior of the metal bellows 3, on the opening 19 there being a bevel 21 which widens the opening to the inside for flow optimization. The top of the bottom plate 17 facing the fluid side 7 is not flat, but in the region bordering the opening 19 forms the greatest thickness with an annular surface 25 which is concentric to the axis 23 and whose radially outer edge is connected to a depression with an annular groove 27 in which an elastomer gasket 29 and a metallic centering ring 31 are held. In the radial direction farther outside of the annular groove 27 on the bottom plate 17 there is a weld spot 33 for the end 35 of the metal bellows 3 which has been welded on fluid-tight. The metallic intermediate ring 31 otherwise keeps the elastomer gasket 29 in its installation position shown in FIG. 1, which in this respect forms stop damping for parts of the bellows 3.

On the top end 37 of the metal bellows 3 its interior is closed fluid-tight by a sealing body 39. The sealing body 39 is made cup-shaped such that the circular ring-shaped peripheral edge 41 which defines a radial plane which is perpendicular to the axis 23 is connected to the cup part which lies radially farther to the inside, the circularly cylindrical side wall 43 of the cup projecting into the interior of the metal bellows 3 so that when the sealing body 39 has reached its end position shown in FIG. 1, with the bellows 3 fully expanded, for the gas side 5 a residual volume remains which has been increased by the interior of the cup. The side wall 43 is connected by the cup bottom 45 which is flat in the interior of the cup. On the bottom 64 of the peripheral edge 41 which borders the end of the bellows is the weld spot 47 at which the welding line for a tight weld to the pertinent end 37 of the bellows 3 is made analogously as in the weld spot 33 on the bottom plate 17.

The guide bodies for guiding the movable end 37 of the bellows 3 are guide shoes 49 which are injection molded from a plastic material with good sliding properties. As is apparent from the drawings, especially from FIG. 2, the guide shoes 49 for the most part have the shape of a short U-profile and are arranged distributed around the peripheral at regular intervals on the sealing body 39, overlapping its peripheral edge 41, in this embodiment there being six guide shoes 49. They each have a profile leg 51 with an arch which is concentric to the axis 23 and form with this profile leg 51 one sliding surface at a time for contact with the inside wall 11 of the housing cylinder 10. This profile leg 51 is connected to the inner profile leg 53 via a crosspiece 55 which overlaps the peripheral edge 41 of the sealing body 39. Here, the crosspieces 55 do not extend above the annular surface 60 of the peripheral edge 41 which defines the upper radial plane, but sit in depressions 62 which are made appropriately for the guide shoes 49 in the peripheral edge 41 and reduce the material thickness of the peripheral edge 41 between its bottom 64 and the annular surface 60 in regions in order to form a seat for the pertinent guide shoe 49. They are locked in the depressions 62 not only against displacement in the peripheral direction, but are also secured against lifting in the axial direction. For this purpose, on the insides of the profile legs 51 and 53 there are catch notches 52 and 54, respectively. When the guide shoes 49 are slipped onto the peripheral edge 41, inner catch shoulders 58 which are made on the elastic profile legs 51, 53 interlock with the catch notches 52 and 54 in the manner of clips.

As already mentioned, besides the guidance of the movable end 37 of the bellows 3 which is formed by the guide shoes 49 on the bottom plate 17, there is additional shaping as guidance and centering which, in the completely contracted position of the bellows 3, see FIG. 2, positions the cup bottom 45. The latter, on its bottom facing the bottom plate 17, has a peripheral projecting annular edge 57 which upon approaching the end position shown in FIG. 2, guided on the slanted surface 59 of the centering ring 31, travels into the centered position in which it rests on the elastomer gasket 29. The elastomer gasket 29 acts not only as a buffer which attenuates contact noise, but seals the fluid entry region on the opening 19 of the bottom plate 17 relative to the residual fluid chamber 61 which remains on the inside of the bellows 3 so that the residual volume of the incompressible fluid located in the chamber 61 additionally contributes to end position damping. The guide shoes 49 are preferably formed from a plastic material such as polytetrafluorethylene (PTFE), which has good sliding properties and which is resistant both to wear and temperature.

As can be taken from FIG. 2, the underside of the cup bottom 45 which is located between the annular edge 57 is not flat, but has a pattern of grooves 63 of small depth so that in the end position the bottom 45 does not form a fluid-tight seal on the edge of the opening 19 so that there remains a passage for the residual fluid here.

1. A guiding device for a metal bellows (3) which on at least one end (37) of the bellows has an end body (39) which can be moved along the wall (11) of a housing (10) when the bellows (3) expands and contracts, there being a guiding element between the end body and the housing (10), characterized in that the guiding element is formed by a plurality of separate guide bodies (49) which are located at distances from one another on the periphery of the end body (39).

2. The guiding device according to claim 1, characterized in that the end body is a sealing body (39) which tightly seals the interior of the bellows (3) on one end (37).

3. The guiding device according to claim 2, characterized in that the sealing body (39) is made cup-shaped and has a circular ring-shaped peripheral edge (41) which overlaps the pertinent end (37) of the bellows (3) and which is connected to a circular cylindrical side wall (43) of the cup which extends into the interior of the bellows (3), and that the guide bodies are formed by guide shoes (49) which in cross section have a U-like profile, and, overlapping the peripheral edge (41) of the cup, with one profile leg (51) at a time form a sliding surface on the housing wall (11).

4. The guiding device according to claim 3, characterized in that on one (51) and/or on both profile legs (51, 53) on the inside there is a catch notch (52 and 54) so that for clip-like locking of the pertinent guide shoe (49) on the peripheral edge (41), catching with a catch shoulder (58) on the side wall (43) of the cup or on the outer periphery of the peripheral edge (41) is enabled.

5. The guiding device according to claim 3, characterized in that the guide shoes (49) are formed by a plastic material with good sliding properties.

6. The guiding device according to claim 1, characterized in that the sealing body (39) of the bellows (3) is designed as a movable separating element between the gas side (5) and fluid side (7) of a hydraulic accumulator, the guide bodies (49) being used as sliding bodies which can be moved along the inside wall (11) of the accumulator housing (10).

7. The guiding device according to claim 6, characterized in that one end (35) of the bellows (3) is fixed on the bottom plate (17) of the accumulator housing (10) which has an opening (19) for fluid entry into the interior of the bellows (3) whose sealing body (39) located on the other end (37) defines within the accumulator housing (10) the respective volumes of the gas side (5) and fluid side (7) which is located within the bellows (3) according to the movements in the expansion and contraction of the bellows (3).

8. The guiding device according to claim 6, characterized in that the bottom (45) of the cup which belongs to the sealing body (39) has an annular rib (57) which projects on the inside of the bellows (3) into the interior of the fluid space (7) and which when the bellows (3) has been completely contracted as an end position limit interacts with a contact and centering arrangement (29, 31, 59) on the bottom plate (17) of the accumulator housing (10).

9. The guiding device according to claim 8, characterized in that the contact and centering arrangement has an annular groove (27) which is recessed in the bottom plate (17) and in which for interaction with the annular rib (57) of the cup an elastomer gasket (29) which the rib adjoins in the end position of the bellows (3), and a metallic centering ring (31) are held, which has an oblique centering surface (59) against which the annular rib (57) of the cup runs when travelling into the end position.

10. The guiding device according to claims 3 to 9, characterized in that the outer surface of the bottom (45) of the cup of the sealing body (39) facing the fluid side (7) has at least one groove-like depression (63).

11. A hydraulic accumulator with an accumulator housing (10) in which the movable separating element between the gas side (5) and fluid side (7) is a metal bellows (3), for the latter there being a guiding device (49) according to one of claim 1.
